(19) United States
(12) Patent Application Publication
(10) Pub. No.: US 2023/0329209 A1
(43) Pub. Date: Oct. 19, 2023

(54) Fishing Rod and Spinning Reel Lockable Rod Holder

(71) Applicant: Steven Loren Morris, Titusville, FL (US)

(72) Inventor: Steven Loren Morris, Titusville, FL (US)

(21) Appl. No.: 17/659,289

(22) Filed: Apr. 14, 2022

(51) Int. Cl. A01K 97/10

(52) U.S. Cl. CPC A01K 97/10

(57) ABSTRACT

The Fishing Rod and Spinning Reel Lockable Rod Holder or Reel Fish Locks (RFL) are lockable fishing rod holders that allows fishing rod and spinning reel combinations to be locked securely together in place to reduce theft.

### BACKGROUND

I grew up fishing the waters of Florida from the time I began walking. Over the years of gaining experience and knowledge in the industry, I quickly became aware of the need for a way to secure my fishing poles without having to cram them into the cab of the truck. After fabricating and attempting many different ideas, my wife and I have come up with a solution that will allow our rods and spinning reels to be safe from theft without having to lock them inside a vehicle. This unique invention will allow for the freedom to temporarily leave rod and reel combos in the boat, in the truck bed, on the pier, or just about anywhere without the worry of them going missing. This system is easy to use, low cost, and will be a must have for anyone who enjoys fishing.

### PRODUCT DESCRIPTIONS

Reel Fish Lock: The original product started with a basic concept to securely lock up fishing rod and spinning reel combinations directly into already installed rod holders. That's when we developed the “Reel Fish Lock”. The product will be made from aluminum or stainless steel and will be produced at a manufacturing business that specializes in custom metal products. This design is tubular in shape, less than a foot in length, has an outer diameter just slightly smaller than most universal rod holders, and a thin nose and neck for the reel body to rest. The neck is an opening less than an inch wide, and a few inches in length. Lying on the bottom of the neck (about midway on product), is a protruding tubular nose an inch in diameter. At the top, middle of the nose is an opening of less than an inch, where the reel body will rest. This nose also has two small holes near the top (just outside of the opening) just large enough for a specific padlock to be inserted. When the bottom of a rod is inserted into this product and the reel body is resting flat on the bottom of the product's neck and nose, it is ready to be locked and secured. The padlock shaft should be inserted into the two small holes on the nose, so that the reel body is securely between the shaft of the padlock and the bottom of the product's nose and neck. This will prevent the rod and reel from being separated from the Reel Fish Lock. To prevent theft, a lockable cable needs to be run through the shaft of the padlock, around a permanent fixture, and locked. Soon after we developed the Reel Fish Lock, we quickly realized that this concept could be expanded into developing new rod holder systems. Using the “Reel Fish Lock” concept, we developed additional products that allows for rods and spinning reels to be securely locked together in place.
6 Inch: Reel Fish Lock 6 inches in length to be used primarily as a spinning reel and fishing rod lock.
10 Inch: Reel Fish Lock 10 inches in length to, be used primarily as a rod holder with the capability of locking a spinning reel and fishing rod.

Boat Mounts: This design will incorporate 1-6 Reel Fish Locks attached to a narrow beam that will have the ability to screw directly into a boat or truck's tool box. Each Reel Fish Lock on this system will require an individual padlock. The system will also require a lockable cable. This concept will allow for one's fishing rods/spinning reels to be securely locked into place while remaining in the boat or truck's bed and in an upright position.

Cooler Rod Holder Attachment: This design will incorporate 2 Reel Fish Locks attached to a hook shaped beam that will fit directly into the side slits of coolers such as Yeti, RTIC, etc. This will provide the ability for the rod and spinning reel combos to be securely locked into place with the cooler. Each Reel Fish Lock on this system will require an individual padlock. The system will also require a lockable cable and a permanent fixture to properly secure rods, spinning reels and cooler.

Surf Rod Holder: Similar to the Reel Fish Lock, this Surf Rod Holder will be attached to a V shaped beam, that can be pushed directly into the ground. This will be specifically designed for surf fishing, fishing from the bank. This will provide the ability for the rod and spinning reel combo to be securely locked into place. The Surf Rod Holder will require an individual padlock. The system will also require a lockable cable and a permanent fixture to properly secure the Surf Rod Holder to the rod and spinning reel.

### Benefits

Reduces theft of rod and spinning reel combinations.

Simple, lightweight, easy to use.

Affordable and cost effective.

Fits most rod and spinning reel combinations.

The Reel Fish Lock can be placed directly into most existing rod holders.

Compatible with many universal padlocks and cables.

### Drawings

FIG. 3: Reel Fish Lock: Front view with padlock.

FIG. 4: Reel Fish Lock: Front view without padlock.

FIG. 5: Reel Fish Lock: Side view without padlock.

FIG. 6: Tool Box Rod Holder: Front view.

FIG. 7: Hitch Rod Holder: Front view.

FIG. 8: Cooler Rod Holder Attachment, Double: Front view.

FIG. 9: Cooler Rod Holder Attachment, Double: Side view.

FIG. 10: Rod Holster: Front view.

FIG. 11: Rod Holster: Side view.

FIG. 12: Surf Rod Holder: Front view and side view.

FIG. 13: Rod Holder Island: Front view.

FIG. 14: Boat Rod Holder Attachment, Triple: Front view.

FIG. 15: Boat Rod Holder Attachment, Quad: Front view.

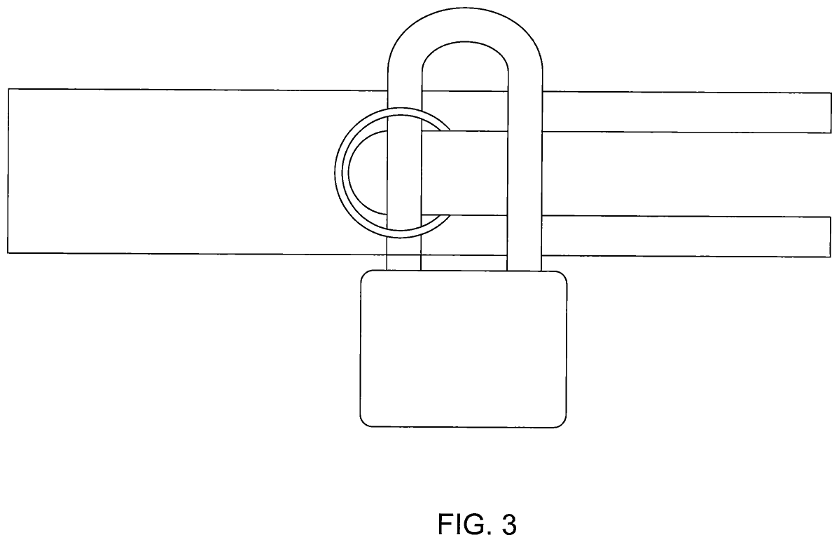

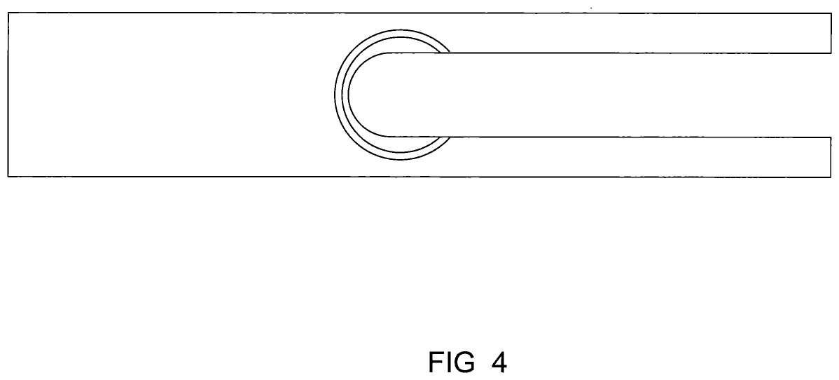

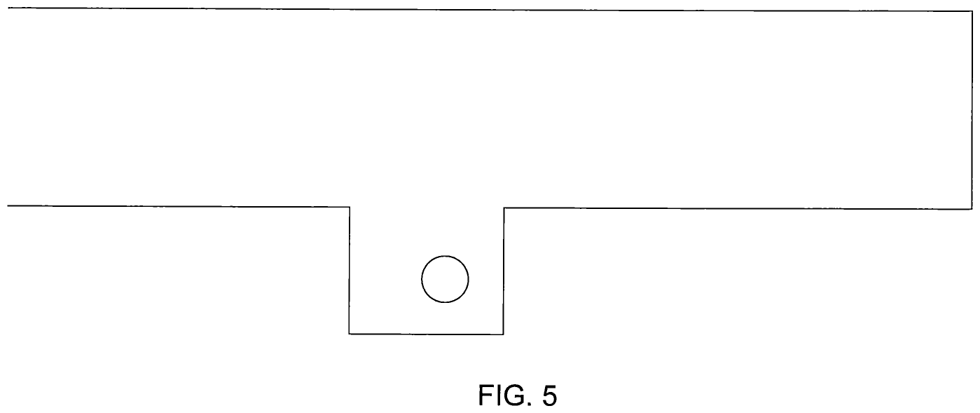

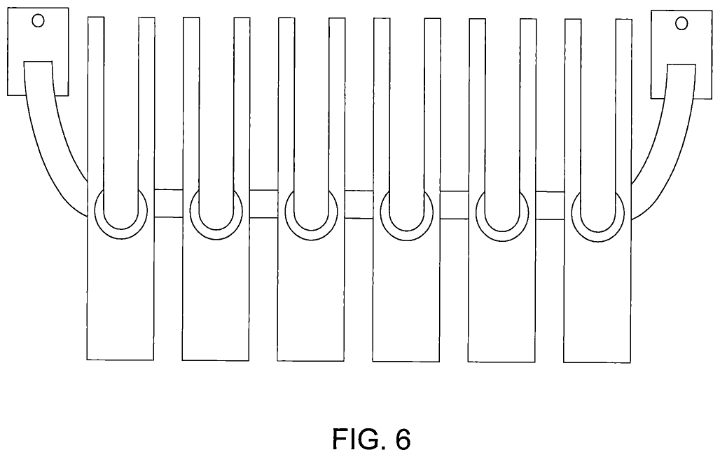

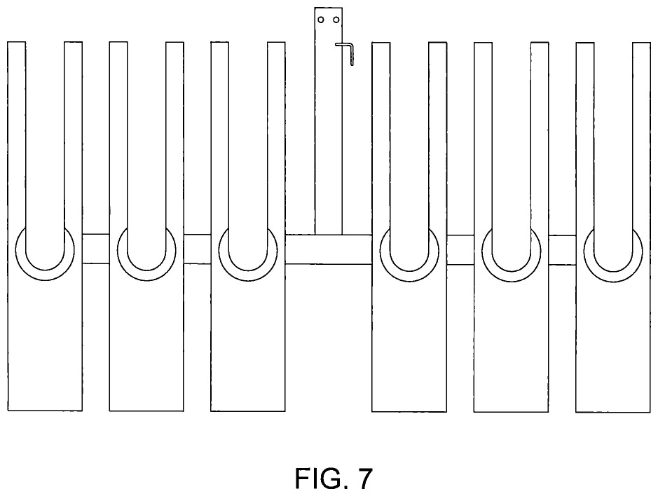

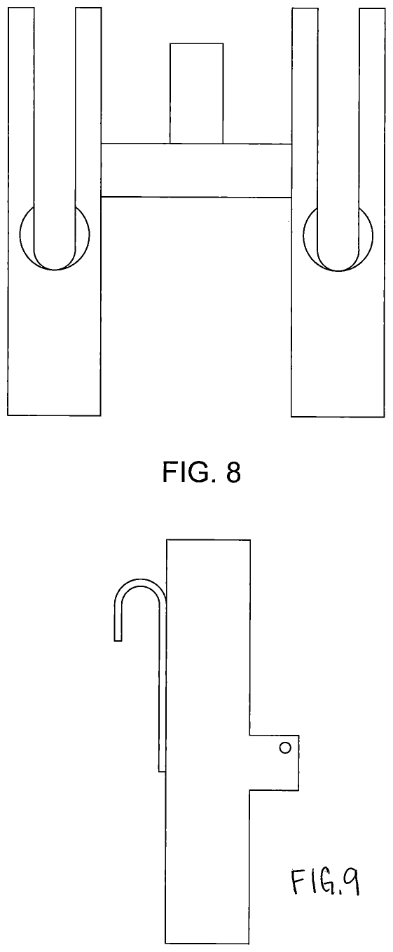

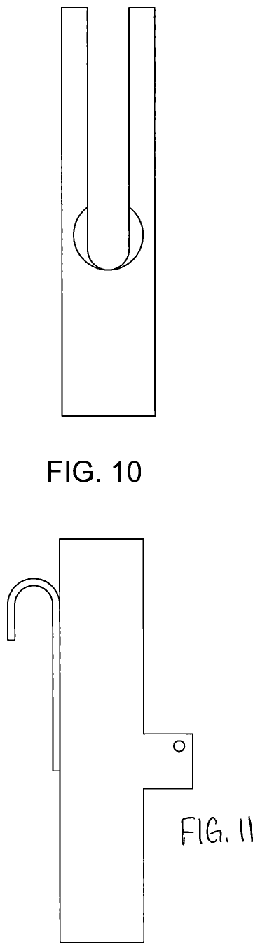

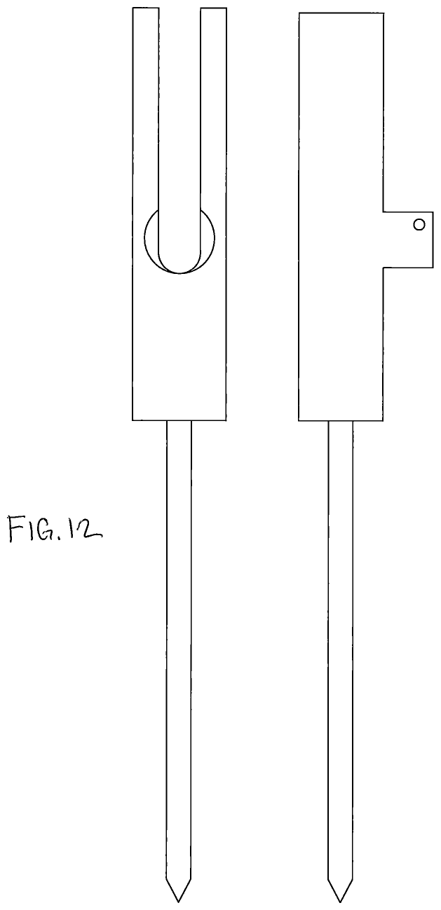

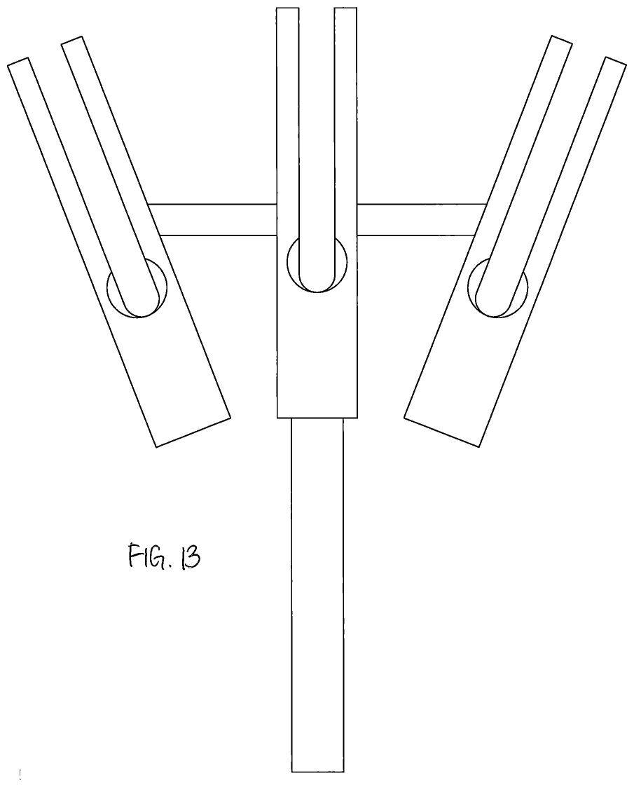

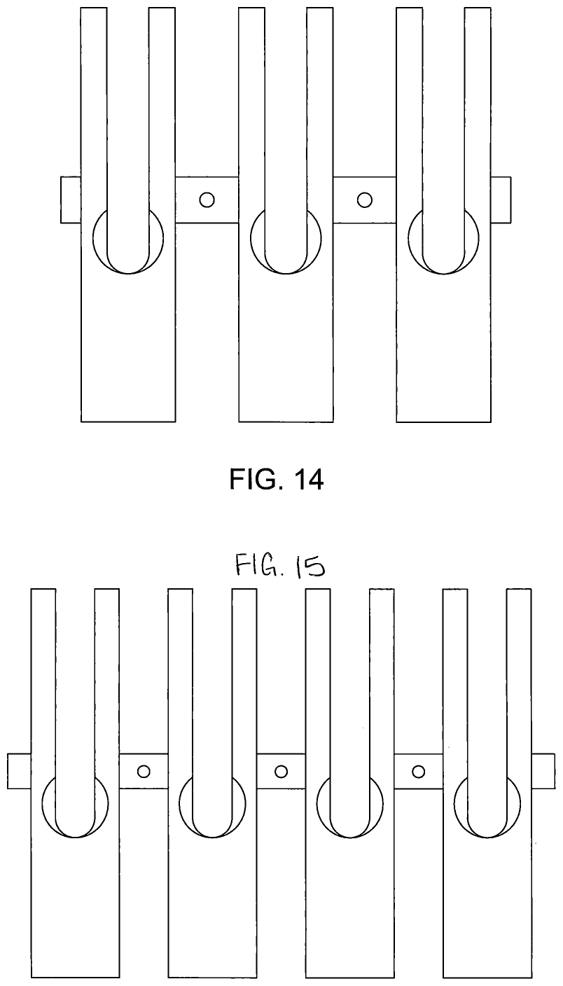

Rod Holder 10″: Locking Rod Holder

Rod Holder 6″: Original Lock

Cooler Attachment: Locking rod holders for cooler, such as YETI or RTIC.

Holder Mount 1: Single locking rod holder mount for boat or durable surfaces.

Holder Mount 2: Double locking rod holder mount for boat or durable surfaces.

Holder Mount 3: Triple locking rod holder mount for boat or durable surfaces.

Holder Mount 4: Quadruple locking rod holder mount for boat or durable surfaces.

Holder Mount 5: Quintuple locking rod holder mount for boat or durable surfaces.

Holder Mount 6: Sextuple locking rod holder mount for boat or durable surfaces.

### DEFINITION

The Fishing Rod and Spinning Reel Lockable Rod Holder or Reel Fish Locks (RFL) are lockable fishing rod holders that allows fishing rod and spinning reel combinations to be locked securely together in place to reduce theft.

1. A tubular fishing rod holder with a lockable feature, comprised of:
(a) Tubular metal rod holder, and
(b) Protruding circular tube, attached to the middle portion of the tubular metal rod holder, with no top third portion and two small circular holes,
Whereby said rod holder can be used, in conjunction with specific padlocks, to lock a fishing rod and spinning reel securely together in place to reduce theft.
